(19) United States
(12) Patent Application Publication
(10) Pub. No.: US 2008/0308470 A1
(43) Pub. Date: Dec. 18, 2008

(54) Logistics System for Transporting Postal Items and Method for Determining a Transport Path

(75) Inventors: Malte Girnus, Darmstadt (DE); Michael Harbaum, Darmstadt (DE); Michael Dressler, Langenlonsheim (DE)

Correspondence Address: International IP Law Group, P.O. BOX 691927, HOUSTON, TX, 77269-1927, US

(73) Assignee: DEUTSCHE POST AG, Bonn (DE)

(21) Appl. No.: 12/096,252

(22) PCT Filed: Dec. 4, 2006
(86) PCT No.: PCT/EP2006/011594

§ 371 Date: Jun. 5, 2008

(30) Foreign Application Priority Data
Dec. 5, 2005 (EP) 05026473.8

(51) Int. Cl. B07C 5/34; G06Q 10/00

(52) U.S. Cl. 209/552; 705/1

(57) ABSTRACT

There is provided a logistics and method a logistics system for transporting a mailpiece along a transportation route within a postal distribution network, the transportation route comprising several nodes of the postal distribution network. An exemplary logistics system comprises a node that corresponds to a delivery point, the node being associated with a first unambiguous identifier and a node that corresponds to a sorting point, the second node being associated with a second unambiguous identifier. The exemplary logistics system further comprises a node that corresponds to a subsequent node in the transportation route being associated with a third unambiguous identifier, the node that corresponds to the subsequent node in the transportation route being associated with another node that either precedes or follows the subsequent node in the transportation route.

### CROSS REFERENCE TO RELATED APPLICATIONS

Pursuant to 35 U.S.C. § 371, this application is the United States National Stage Application of International Patent Application No. PCT/EP2006/011594, filed on Dec. 4, 2006, the contents of which are incorporated by reference as if set forth in their entirety herein, which claims priority to EP Patent Application No. 05026473.8, filed Dec. 5, 2005, the contents of which are incorporated by reference as if set forth in their entirety herein.

### BACKGROUND

Exemplary embodiments of the present invention relate to a logistics system for transporting a mailpiece along a transportation route within a postal distribution network.

Furthermore, exemplary embodiments of the present invention relate to a method for specifying the transportation route of a mailpiece within a postal distribution network.

A mailpiece is normally transported to a delivery point such as, for example, a street address or a post office box, via a transportation route comprising several sorting points at which the mailpieces are distributed among additional nodes of a postal distribution network.

Normally, it is provided that mailpieces that are sent out in a certain region are collected in a distribution center of a postal service provider where, within the scope of so-called outgoing sorting, the mailpieces are distributed among the destination regions. In the distribution center of the destination region, within the scope of so-called incoming sorting, fine sorting is carried out in which the mailpieces are distributed especially among the individual delivery districts, where they are then delivered by a mail carrier.

Fine sorting programs for the sorting devices of the distribution centers are provided in the destination region in order to carry out the fine sorting of the mailpieces. Within the scope of a fine sorting program, mailpieces are sorted that are to be delivered in certain delivery districts belonging to the service area of the distribution center. Here, the fine sorting is already prepared at the time of the outgoing sorting of the mailpieces in that, within the scope of the outgoing sorting, the mailpieces are distributed among sorting points that are associated with a so-called fine sorting program of the incoming sorting. Here, during the incoming sorting, it is also possible for several fine sorting programs to be provided, whereby the mailpieces of a fine sorting program are distributed among the subsequent fine sorting programs.

Consequently, in order to transport the mailpieces, delivery points are combined to form delivery districts, and delivery districts are, in turn, combined to form groupings of delivery districts that are each associated with a fine sorting program that is associated with a certain distribution center.

Thus, the transportation route of the mailpieces from the distribution center of the source region to a delivery point encompasses the distribution center of the destination region of the mailpiece, the machine inlet of the sorting device provided for the fine sorting, optionally the machine inlets for additional fine sorting programs, the delivery district that is associated with the delivery address of the mailpiece as well as the delivery point where the mailpiece is delivered.

According to the state of the art, for purposes of sorting the mailpieces, they are provided with code in which the applied delivery address is encoded. As used by the applicant, this is an eleven-digit code that contains the five-digit postal code of the address, encoded information about the street section of the delivery address as well as information about the house number. The postal code designates a certain delivery district group encompassing the delivery district with which the mailpiece is associated. The first two digits indicate the region, which generally corresponds to a service area of a distribution center.

On the basis of this sorting code, which already indicates certain groupings of delivery points such as, for example, delivery district groups or a service area of a distribution center, according to the state of the art, a specification is also made of the transportation route or of the nodes of the mail distribution network that are present in the transportation route and that are permanently associated with their sorting code.

As a result, it is only possible to change the transportation route of a mailpiece to a limited extent or with great effort and in an unclear manner since the delivery points are associated with a fixed sorting code that already contains the information about certain nodes of the transportation route such as, for example, the distribution center for the incoming sorting.

Moreover, the problem exists that the specification of the transportation routes of mailpieces, which is normally done within a database system, is very unclear and prone to error if the provided nodes of the transportation route do not match the information within the sorting code, which is the case, for example, if the incoming sorting of a mailpiece is to be carried out in a distribution center that is associated with a different region than the destination region indicated in the sorting code for that mailpiece.

Moreover, it is hardly or not at all possible to integrate nodes into the postal distribution network that cannot be described on the basis of the provided sorting code such as, for example, nodes of the postal distribution network of another country or of another postal service provider that uses different sorting codes.

### SUMMARY OF THE INVENTION

An objective of an exemplary embodiment of the present invention is to make it possible to specify the transportation route of a mailpiece within a postal distribution network independently of the sorting code.

Accordingly, it is provided that a logistics system of the type described above is configured in such a way that an unambiguous identifier is associated with the nodes within the database and in that the identifier of a second node is associated with a first node within the database, the second node preceding or following the first node along the transportation route of the mailpiece.

The term logistics system is used within the scope of an exemplary embodiment of the present invention in a broad sense. In particular, it comprises systems that have the requisite means and devices to carry out the transportation of mailpieces from an outgoing location to a delivery point along a transportation route within a postal distribution network.

A method according to an exemplary embodiment of the present invention for specifying a transportation route of a mailpiece within a postal distribution network the transportation route comprising several nodes of the postal distribution network, in particular a node that corresponds to a delivery point, as well as at least one node that corresponds to a sorting point, and the transportation route being stored in a database is characterized in that an unambiguous identifier is associated with the nodes within the database and in that the identifier of a second node is associated with a first node within the database, the second node preceding or following the first node along the transportation route of the mailpiece.

Thus, an exemplary embodiment of the present invention relates to associating an unambiguous identifier with each node of the postal distribution network and of specifying the transportation route of a mailpiece within the postal distribution network in that a node is also associated with the identifier of the preceding node along the transportation route of the mailpiece or of the following node along the transportation route of the mailpiece.

Consequently, one exemplary embodiment of the present invention yields the transportation route of a mailpiece that is addressed to a certain delivery point, starting from the node that corresponds to the delivery point. On the basis of the information that is associated with this node and that relates to the identifier of the preceding node along the transportation route, it is ascertained which one is the preceding node. On the basis of the information that is associated with this node and that relates to the identifier of the preceding node, the node that precedes this node along the transportation route can be ascertained, etc.

In another exemplary embodiment of the present invention, a node is associated with the identifier of the node that follows along the transportation route, as a result of which the transportation route of the mailpiece can likewise be ascertained from a first node via additional nodes all the way to the node that corresponds to the delivery point of the mailpiece.

In this context, within the scope of an exemplary embodiment of the present invention, the nodes of the logistics network correspond especially to delivery points or sorting points of the postal distribution network. At the sorting points, mailpieces that are addressed to certain delivery points are sorted out of the stream of mail. From the sorting point, the mailpieces are relayed to additional nodes of the postal distribution network which can be, for example, delivery points or other sorting points. Moreover, a node of the postal distribution network can also represent an area, especially a geographic area, that encompasses certain delivery points. An example of such a node is a street section of a town that contains the indicated street addresses.

The specification of the transportation route of a mailpiece according to an exemplary embodiment of the present invention depends on the sorting code described above. With this approach, in the transportation route of a mailpiece, it is possible to take into account nodes of various partial areas of the postal distribution network in which various sorting codes or postal code systems are provided. Moreover, an exemplary embodiment of the present invention may provide the advantage that the transportation route of a mailpiece can be changed in a simple manner in that the identifier that is associated with a node and that identifies a preceding or following node along the transportation route is adapted.

Therefore, in an especially preferred embodiment of the logistics system according to an exemplary embodiment of the present invention and of the method according to the invention, it is provided that the association of the identifier of the second node with the first node is variable.

A logistics system in accordance with an exemplary embodiment of the present invention and of the method according to an exemplary embodiment of the present invention may provide that, except for the first node of the transportation route, each node contained in the transportation route of a mailpiece is associated with the identifier of the preceding node along the transportation route.

Moreover, a logistics system in accordance with an exemplary embodiment of the present invention and of the method according to an exemplary embodiment of the present invention may provide that, except for the node that corresponds to the delivery point of the mailpiece, each node contained in the transportation route of a mailpiece is associated with the identifier of the node that follows along the transportation route.

Another logistics system according to an exemplary embodiment of the present invention and of the method according to an exemplary embodiment of the present invention is characterized in that descriptive attributes are associated with the nodes.

In this manner, it is especially easy to ascertain to which delivery point or sorting point the node corresponds.

A refinement of the logistics system according to an exemplary embodiment of the present invention and of the method according to an exemplary embodiment of the present invention provides that a node that corresponds to a delivery point is associated with at least one feature of a mailpiece addressed to the delivery point.

A logistics system according to an exemplary embodiment of the present invention and of the method according to an exemplary embodiment of the present invention may be characterized in that a node that corresponds to a delivery point is associated with a delivery address that is to be applied onto a mailpiece addressed to the delivery point.

In this way, on the basis of the delivery address associated with the delivery points, the nodes of the postal distribution network with which these delivery points are associated can be identified in a simple manner.

An exemplary embodiment of the present invention may also make it possible for nodes of the postal distribution network that correspond to delivery points to be defined not exclusively or not at all on the basis of the delivery address, but rather for additional mailpiece features to be used to define nodes, where, in general, any mailpiece features that can be detected in any way can be used for this purpose.

An example of such a mailpiece feature is information that is applied onto the mailpiece indicating a delivery company that delivers the mailpiece.

Therefore, a logistics system according to an exemplary embodiment of the present invention and of the method according to an exemplary embodiment of the present invention may provide that a node is associated with a delivery company that transports a mailpiece to the node.

In one exemplary embodiment of the logistics system according to the present invention and of the method according to an exemplary embodiment of the present invention, it is especially provided that a node that may correspond to a delivery point is associated with a delivery company that delivers mailpieces to this delivery point.

Here, in particular, several nodes that correspond to delivery points within the postal distribution network can be provided for a delivery address, said nodes each being associated with a certain delivery company. In this manner, the transportation route of a mailpiece that is delivered by a first delivery company can contain nodes preceding the delivery point that are different from the transportation route of a mailpiece that is delivered to the same delivery address by a different delivery company. In particular, nodes can be provided at which mailpieces from the first delivery company or from another delivery company are handed over to the second delivery company.

Furthermore, in a preferred embodiment of the logistics system according to the invention and of the method according to an exemplary embodiment of the present invention, it may be provided that the transportation route of the mailpiece is specified in a database.

The database is preferably a part of the logistics system according to the invention.

Moreover, a logistics system according to an exemplary embodiment of the present invention and of the method according to an exemplary embodiment of the present invention may be characterized in that an association between the nodes of the transportation route and the unambiguous identifiers is stored in the database.

A logistics system according to an exemplary embodiment of the present invention and of the method according to an exemplary embodiment of the present invention may provide that an association between the nodes of the transportation route and their attributes is stored in the database.

In a logistics system according to an exemplary embodiment of the present invention and of the method according to an exemplary embodiment of the present invention, it may also be provided that an association between a first node and a second node is stored in the database, the second node preceding or following the first node along the transportation route of the mailpiece.

Moreover, a logistics system according to an exemplary embodiment of the present invention and of the method according to an exemplary embodiment of the present invention may be characterized in that, during the sorting at a sorting point, on the basis of a sorting plan, the mailpiece is relayed to a node that follows along the transportation route of the mailpiece.

A logistics system according to an exemplary embodiment of the present invention and of the method according to an exemplary embodiment of the present invention may provide that the sorting plan is generated within the database on the basis of the specification of transportation routes of mailpieces.

In a logistics system according to an exemplary embodiment of the present invention and of the method according to an exemplary embodiment of the present invention, it may be provided that the unambiguous identifier of a node associated with a delivery point can be applied onto a mailpiece addressed to the delivery point and can be used during the sorting of the mailpiece.

A logistics system according to an exemplary embodiment of the present invention and of the method according to an exemplary embodiment of the present invention may provide that nodes are contained in the transportation route of mailpieces that are addressed to a delivery point that corresponds to a node of the postal distribution network, the identifiers of said nodes, within the sorting plan, being associated with the node that corresponds to the delivery point.

In a logistics system according to an exemplary embodiment of the present invention and of the method according to an exemplary embodiment of the present invention, it may be provided that a sorting code and/or a sorting code range is associated with the nodes.

A logistics system according to an exemplary embodiment of the present invention and of the method according to an exemplary embodiment of the present invention may also be characterized in that a node that corresponds to a delivery point is associated with a sorting code that can be applied onto a mailpiece addressed to the delivery point and that can be used during the sorting of the mailpiece at a sorting point.

Another logistics system according to an exemplary embodiment of the present invention and of the method according to an exemplary embodiment of the present invention may provide that, from a first node that corresponds to a sorting point, the mailpiece is relayed to a second node that follows along the transportation route, said second node being associated, within the sorting plan, with the sorting code applied onto the mailpiece and/or with a sorting code range that contains the sorting code applied onto the mailpiece.

### BRIEF DESCRIPTION OF THE DRAWING

FIG. 1 is a diagram that illustrates various nodes of the partial area of the postal distribution network that comprises the service area of a distribution center in a logistics system according to an exemplary embodiment of the present invention, as well as relationships between the nodes.

### DETAILED DESCRIPTION OF SPECIFIC EMBODIMENTS

Exemplary embodiments of the present invention will be explained below with reference to the example of a logistics system that is configured to transport mailpieces from an outgoing location to a destination and that comprises several distribution centers operated by a delivery company in which the outgoing sorting as well as the incoming sorting of mailpieces is carried out in such a way as was already outlined above.

Mailpieces that are dropped off in a given region are collected in the distribution center that is associated with this region. Within the scope of the outgoing sorting that is carried out in this distribution center, the mailpieces are then distributed among the distribution centers that are each intended for the incoming sorting of the mailpieces. Within the scope of the incoming sorting, a one-stage or multi-stage fine sorting is carried out in order to further distribute the mailpieces to the mail carriers or recipients. At each stage, the mailpieces are sorted within the scope of a fine sorting program comprising the sorting of mailpieces that are addressed to certain delivery points.

Therefore, in the outgoing sorting, it is provided that the mailpieces are already presorted for the fine sorting program of the first stage. The mailpieces intended for the various fine sorting programs of the incoming sorting of a certain distribution center are combined into a batch within the scope of the outgoing sorting process. The batch comprises several containers, each containing mailpieces that are taken to a sorting program of the incoming sorting, the sorting program being preferably indicated on the containers. After the batches have been assembled, the batch is transported to the distribution center that is responsible for the incoming sorting of the mailpieces in question. This distribution center corresponds to the first node of the transportation route of the mailpieces.

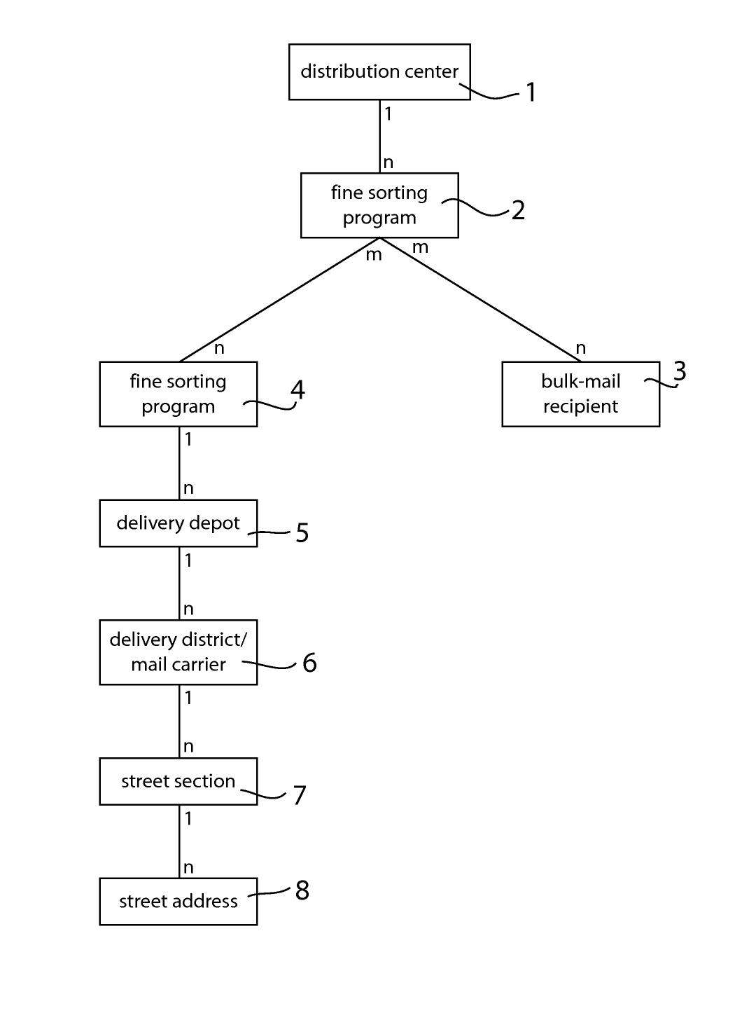

FIG. 1 shows an example of various types of nodes of the partial area of the postal distribution network that comprises the service area of a distribution center provided for the incoming sorting. The diagram in FIG. 1 also illustrates the normally present hierarchical structure of the nodes in which each node of a higher hierarchical level is associated with several nodes of a lower hierarchical level, as can be seen from the cardinalities indicated in the diagram.

As mentioned above, the distribution center itself corresponds to a first node 1 of the transportation route of mailpieces. The mailpieces that are dropped off at the distribution center are first distributed among the fine sorting programs of the first stage. Thus, node 1 is a sorting point of the postal distribution network.

In the embodiment of the logistics system shown in FIG. 1 by way of an example, it is provided that, for mailpieces that are addressed to a street address as well as for mailpieces that are addressed to a bulk-mail recipient, several first fine sorting programs are executed that represent nodes 2 of the postal distribution network to which the mailpieces dropped off at the distribution center are first taken.

In this context, a bulk-mail recipient is a recipient that regularly receives a large number of mailpieces, for example, 200 mailpieces every workday. As used by the applicant, mailpieces intended for a bulk-mail recipient are addressed with the name of the bulk-mail recipient, a city as well as a bulk-mail recipient postal code, which the bulk-mail recipient leases from the postal service provider. The mailpieces are not delivered by a mail carrier but rather directly from the distribution center.

At the sorting points that correspond to the nodes 2 or by the corresponding fine sorting programs, the mailpieces for the various bulk-mail recipients that receive their service from the distribution center are combined into a delivery that is delivered to the specific bulk-mail recipient after the sorting has been completed. The bulk-mail recipients are each a delivery point that corresponds to a node 3 of the postal distribution network.

For the mailpieces that are addressed to street addresses, it is provided that, on the basis of the fine sorting programs of the first stage, a presorting for fine sorting programs of the second stage is carried out which, in turn, correspond to additional sorting points or nodes 4 of the postal distribution network. These fine sorting programs can be, for example, sorting programs that sort the mailpieces according to a delivery route sequence of the mailpieces in which the mailpieces are arranged in the sequence in which they are delivered to the street addresses by the mail carriers, using a method known to the person skilled in the art.

After these fine sorting programs have been executed, the mailpieces, preferably arranged according to delivery districts, are filled into containers. In the distribution center, the containers are then combined into batches, whereby a batch comprises the containers that contain mailpieces for the delivery districts that are associated with a delivery depot. A delivery depot is a facility within the logistics system where several mail carriers receive the mailpieces that are to be delivered within their delivery district and where they prepare their delivery route. The delivery depots correspond to additional nodes 5 of the postal distribution network.

After the batches have been filled into the containers, the various batches are transported from the distribution center to the various delivery depots. In the delivery depots, the containers, each containing mailpieces for a certain delivery district, are distributed among the mail carriers who then deliver the mailpieces to the delivery points of a delivery district. A delivery depot is thus likewise a sorting point.

Here, it can also be provided that the service areas of various distribution centers overlap and that mailpieces are taken to a delivery depot whose incoming sorting is carried out in different distribution centers. Thus, for example, the incoming sorting of mailpieces for a first delivery district that is associated with the delivery depot because of its geographic proximity to the delivery depot can be carried out in a different distribution center than the incoming sorting of mailpieces of other delivery districts that are associated with the delivery depot.

The delivery districts or the mail carriers (to put it more precisely, the bags into which the mail carriers put the mailpieces they are to deliver in order to transport them) correspond here to additional nodes 6 of the postal distribution network, which are, in principle, likewise sorting points, since the mail carriers distribute the mailpieces to the street addresses (or the mailpieces that are in the bags are distributed among the street addresses).

The delivery districts comprise several street sections of the street network of one or more towns and correspond to additional nodes 7 of the postal distribution network. The street sections, in turn, comprise prescribed street addresses to which mailpieces are delivered. Therefore, the street addresses correspond to delivery points that constitute nodes 8 of the postal distribution network.

The relationships between the nodes of the mail distribution center, that is to say, especially the association of nodes of a lower hierarchical level with a higher hierarchical level such as, for example, the association of street addresses with a street section or the association of street sections with a delivery district are specified within the logistics system in a database system and stored in a database whose data stock is used especially for generating sorting plans that are the determining factor for the sorting of the mailpieces on the basis of the fine sorting programs and for the sorting programs executed within the scope of the outgoing sorting.

Consequently, within the scope of an exemplary embodiment of the present invention, it may be provided that, for each node within the postal distribution network, a data object is stored in the above-mentioned database. Moreover, each node is associated with an unambiguous identifier that unambiguously identifies said node within the entire postal distribution network or within the entire logistics system.

In a preferred embodiment of the invention, the identifier is a so-called UUID (Universally Unique Identifier) or a GUID (Globally Unique Identifier) with which the non-ambiguity of the identification of a node is ensured at least over a very long period of time. In principle, such identifiers are familiar to the person skilled in the art and functionalities relating to their generation are already contained in conventional database systems such as, for example, the familiar database system of the ORACLE company. For example, the identifier here is configured as a code with 16 bytes (32 characters) that is made up of an ID of the generating database system and of an ID of the generating database process.

The identifier associated with a node of the postal distribution network—below also referred to as RIO-ID—is preferably stored in the data object that is associated with the node within the database. Moreover, the data object contains descriptive attributes of the node.

Data objects that are associated with a delivery point contain especially attributes that correspond to mailpiece features such as, for example, the delivery address applied onto the mailpiece, which the mailpieces addressed to the delivery points have or need to have.

The attributes associated with a street address are especially the name of the specific town and of the specific street, the specific house number as well as the postal code that is associated with the street address. The attributes associated with a bulk-mail recipient are especially the name of the bulk-mail recipient, that is to say, for example, the name of the company that is the bulk-mail recipient, the postal code of the bulk-mail recipient as well as the geographic address of the bulk-mail recipient comprising the name of a town and a street, a house number and a postal code.

The descriptive attributes associated with a street section are especially the name of the town and of the street where the street section is located. Descriptive attributes of a delivery district and of a delivery depot are, for example, the name of the town where the delivery district or the delivery depot is located, as well as an ID that describes the delivery district and the delivery depot. The IDs of the delivery depot and of the delivery district can be applied, for example, after the incoming sorting has been carried out, onto the containers that are transported to a certain delivery depot and that contain mailpieces intended for a certain delivery district associated with the delivery depot. Here, the IDs allow especially the manual assorting the containers in the distribution center where the outgoing sorting is carried out as well as the manual distribution of the containers among the delivery districts in the delivery depots.

A distribution center can likewise be associated with the name of the town where it is located as well as with an ID that describes the distribution center. As an attribute, a sorting program is preferably associated with an indication of the sorting plan that is based on said program as well as a designation of the sorting program and an ID of the sorting device in which the sorting program is executed. The ID of the sorting program and/or the IDs of the sorting machine that executes the sorting program as well as the ID of the distribution center where the sorting device is located can be applied, for example, onto the containers that, after the outgoing sorting, are assorted in the distribution center and then transported to the distribution center where the incoming sorting is carried out.

Moreover, additional attributes can also be associated with the nodes of the postal distribution network. For example, as a matter of principle, a delivery point can be associated with all of the features of a mailpiece addressed to the delivery point that can be detected in any way.

If the mailpieces are delivered to a street address by various delivery companies within the logistics system, then in particular, two nodes within the postal distribution network can be provided for the street address, each of which is associated with a mail carrier. As attributes, these nodes can be associated with the information present on the mailpieces of the delivery company scheduled for the delivery. The mailpieces addressed to one of the two nodes on the basis of the delivery address and on the basis of the information about the delivery company can be distributed—for example, within the scope of the incoming sorting in a distribution center—among the delivery depots of both delivery companies which then take over the further transportation of the mailpiece to the street address in the manner already described or in some other manner.

In another example of an advantageous exemplary embodiment of the invention, it can be provided that, for rush deliveries addressed to a street address, a different transportation route is provided than for the other mailpieces addressed to this street address. In this case, within the scope of an exemplary embodiment of the present invention, two nodes are likewise provided within the postal distribution network for the street address and these nodes are associated with the appropriate attributes.

In addition to the descriptive attributes presented above by way of an example, in a preferred first exemplary embodiment of the invention, the data objects associated with a node also contain the RIO-ID of the immediately preceding node along the transportation route of the mailpieces. Starting from a delivery point, the data objects associated with the nodes thus contain references to the immediately preceding node along the transportation route. The data object associated with the first node of the transportation route contains no reference to a preceding node. As a rule, the first node of the transportation route of a mailpiece corresponds to the distribution center where the incoming sorting of the mailpiece is carried out or corresponds to the fine sorting program provided in the first stage of the incoming sorting.

With respect to the diagram in FIG. 1, this means that the RIO-ID that is associated with the appertaining node in the next-higher hierarchical level is contained in each data object that is associated with a node in a certain hierarchical level. In particular, in the case of the embodiment illustrated in FIG. 1, the RIO-ID of the street section that is associated with the street address is contained in a data object that is associated with a street address. The data object associated with a street section contains the RIO-ID of the delivery district with which the street section is associated, etc.

In this exemplary embodiment of the invention, if it is provided that mailpieces from two different distribution centers have to be taken to one delivery depot, two nodes have to be provided within the postal distribution network for this delivery depot, the first of which is contained in the transportation route of the mailpieces whose incoming sorting is carried out in a first distribution center, while the second is contained in the transportation route of mailpieces whose incoming sorting is carried out in the second distribution center.

The transportation routes of mailpieces that are addressed to certain delivery points are unambiguously specified on the basis of the associations between nodes of the postal distribution network and the preceding nodes along the transportation routes of mailpieces. They can be ascertained in that, starting from the delivery point, the preceding nodes are successively specified.

In the embodiment of the logistics system shown in FIG. 1, the transportation route for a mailpiece that is addressed to a street address is obtained, for example, in that, for the street address, first of all the street section containing the street address is ascertained. Then, for the street section, the delivery district that is associated with the delivery district is ascertained and, for the delivery district, the delivery depot that is associated with the delivery district is ascertained, etc.

In this exemplary embodiment of the invention, a change in the transportation route is possible in a simple manner in that a certain node that is supposed to be preceded by a different node than the currently provided preceding node is associated with the identifier of the new preceding node rather than with the currently associated identifier. If it is provided that a street section is to be associated with a different delivery district, then, in the data object that is associated with the street section, the identification number of the new delivery district is associated instead of the identification number of the delivery district that had been associated so far.

In a likewise advantageous second exemplary embodiment of the invention, it is provided that the data objects that are associated with nodes of the postal distribution network contain information about the RIO-ID of the following node along the transportation route of the mailpiece instead of containing information about the RIO-ID of the preceding node. Therefore, the data object of the first node of the transportation route of a single mailpiece contains the RIO-ID of the second node of the transportation route, the data object associated with this node contains the RIO-ID of the third node, etc. Finally, the data object that is associated with the node that precedes the delivery point of the mailpiece along the transportation route contains the identifier of the delivery point. In this exemplary embodiment of the invention, the data object associated with the delivery point does not contain a reference to an additional node.

Since, in this manner, the transportation routes of mailpieces to all delivery points of the postal distribution network containing the same first node are specified, the data object that is associated with a certain node thus contains the identification codes of all of the nodes that follow along the transportation route of at least one mailpiece. In this manner, starting from the first node on these transportation routes, all of the mailpiece transportation routes containing the first nodes can be specified.

In order to ascertain a single transportation route for mailpieces that are addressed to a certain delivery point, in this exemplary embodiment of the invention, all of the data objects that are associated with possible nodes that precede the delivery point first have to be checked as to whether they contain the RIO-ID of the delivery point. After the determination of the data object containing the RIO-ID of the preceding node, all of the data objects that are associated with nodes that possibly precede this node are checked as to whether they contain the RIO-ID of this node, etc. Here, it is especially advantageous to associate each node with a type designation that makes it possible to specify the possible preceding nodes.

Regarding the embodiment of a postal distribution network shown in FIG. 1, this means that, in order to specify the transportation route of mailpieces that are addressed to a certain delivery point, firstly, all of the data objects that are associated with nodes of the street section type are checked as to whether they contain the RIO-ID of the delivery point. If the street section that is associated with the delivery point has been ascertained, then all of the data objects that are associated with nodes of the delivery district type are also checked as to whether they contain the RIO-ID of the ascertained delivery depot, etc.

If mailpieces whose incoming sorting is carried out in different distribution centers are taken to a certain delivery depot, then in this exemplary embodiment of the present invention, it is not necessary to provide several nodes for the delivery depot within the postal distribution network.

In this exemplary embodiment of the present invention, a change in the transportation routes of the mailpieces can also be effectuated very easily in that the associations between the nodes are adapted. If a different preceding node than the currently provided one is to be specified for a certain node, then the RIO-ID of the node is deleted in the data object that is associated with the currently preceding node and the RIO-ID of the node is stored in the data object that is associated with the new preceding node.

If, for example, a street section is to be associated with a second delivery district instead of a first one, then the RIO-ID of the street section is deleted in the data object that is associated with the first delivery district and it is stored in the data object that is associated with the second delivery district.

The storage of the data objects associated with the nodes of the postal distribution network as well as the specification of the transportation routes of mailpieces in the database is preferably carried out within the scope of an exemplary embodiment of the present invention on the basis of several tables that are described below. By way of an example, the embodiment of the invention taken here is one in which it is provided that the transportation route of a mailpiece is specified in that the data object of a node of the transportation route contains the RIO-ID of the preceding node along the transportation route.

The existing types of nodes are defined in a first table having the designation NODETYPE. This table contains the following columns:
NODETYPE_ID, where identification numbers associated with node types are stored
NAME, where the designations of the types are indicated such as, for example, “street section”
LEVEL, where it is indicated which hierarchical level the nodes of the various types are associated with (here, for example, Level 1 can be associated with the nodes of the distribution center type and Level 2 can be associated with the nodes that correspond to the fine sorting program of the first stage)

Moreover, there is a table having the designation TARGETTYPE_LINK in which the hierarchy of the node types is indicated and which contains the following columns:
NODETYPE_LINK_ID, where the identification numbers of the relationships between two node types indicated in the lines are stored
NODETYPE_ID_A, where the identification numbers of the superordinated node types of a node type pair indicated in the table TARGETTYPE are indicated
NODETYPE_ID_B, where the identification numbers of the subordinated node types of the node type pair indicated in the table TARGETTYPE are indicated

In order to store the individual nodes of the postal distribution network and their association with each other, three so-called set-up tables are used.

A first set-up table having the designation TYPE defines the possible formats of the database entries or attributes of the data objects. Here, for example, the formats NUMBER for numbers or VARCHAR2 for character strings of a variable length can be provided. The table contains the following columns:
TYPE_ID, where identification numbers of the formats are stored
NAME, where the designations of the formats are indicated

In a second set-up table having the designation KEY, the type of possible entries or the attributes of the data objects are defined. The type of an attribute indicates, for example, whether it is a name, a postal code or a house number. The KEY table contains the following columns:
KEY_ID, where the identification numbers of the types of attributes are stored
NAME, where the designation of the types of attributes are indicated
SHORT_NAME, where abbreviations of the types of attributes are stored (e.g. PC for postal code)

Another set-up table having the designation KEY_NODETYPE specifies which attributes can be associated with nodes of a certain node type. The table contains the following columns:
KEY_NODETYPE_ID, where identification numbers of the associations of an attribute with a node type indicated in the lines are stored
KEY_ID, where the identification numbers of the attributes that are associated with these in the KEY table are stored
NODETYPE_ID, where the identification numbers of the node types associated with the attributes are stored, whereby the identification numbers are associated with the node types in the NODETYPE table

The data associated with the individual nodes is stored on the basis of two tables having the designations NODES and KEY_VALUE_TYPE; the NODES table preferably contains the following columns:
NODE_ID, where identification numbers of the nodes are stored
NODETYPE_ID, where the node types of the nodes are indicated
RIO_ID, where the RIO-IDs of the nodes are indicated
RIO_ID_MASTER, where the RIO-IDs of the nodes preceding along the transportation route of a mailpiece are indicated

The KEY_VALUE_TYPE table indicates the attributes of the nodes and contains the following columns:
KEY_VALUE_TYPE_ID, where identification numbers of the associations indicated in the lines are stored
TYPE_ID, where the identification numbers of the formats of the attributes indicated in the lines are determined, whereby the identification numbers are associated with the formats in the TYPE table
KEY_NODETYPE_ID, where the identification numbers of the associations indicated in the KEY_NODETYPE table between the node types and the possible attributes are stored (the entries in this column thus show that a certain attribute of a certain node type is indicated, such as the name of the street that is associated with a street section, or that the name of a bulk-mail recipient is indicated)
VALUE, where the values of the attributes are indicated (for example, the value “50” for a house number of a street section or the value “Garden Road” for the name of a street that is associated with a street section)
NODE_ID, where the identification numbers of the nodes that are associated with these in the NODES table are indicated

A data object that is associated with a distribution object thus comprises the line in the NODES table that is associated with this node as well as the lines in the KEY_VALUE_TYPE table that are associated with this node.

In the lines of the KEY_VALUE_TYPE table that are associated with a certain node, the associations between the attributes that the node has and their values are indicated. The attributes of a node are thus advantageously stored as so-called key-value pairs.

In comparison to the likewise conceivable storage of the attributes within a table in which a column is provided for each possible attribute of a node, this has the advantage that the creation of incompletely filled data records is avoided. For example, in such a table, a column would have to be provided where the name of a bulk-mail recipient is indicated. In this column, however, only the nodes corresponding to a bulk-mail recipient would have an entry. In contrast, with all of the other types of nodes, the fields of this column would remain empty.

The described database or the specification of the mailpiece transportation routes contained in the database can especially be used for drawing up the sorting plans according to which the sorting at the sorting nodes is carried out, whereby preferably one sorting plan is drawn up for each sorting node of the postal distribution network.

The sorting programs of the outgoing sorting and on the fine sorting programs of the incoming sorting that are executed in the sorting systems of the distribution centers are based on the sorting plan. On the basis of the sorting plans, it is specified within the scope of a sorting program which mailpieces are diverted into which sorting compartment of the sorting systems having several sorting compartments. Each sorting compartment is associated with a node of the postal distribution network to which the mailpieces that are diverted into the compartment are then relayed.

Within the sorting systems, the sorting is normally carried out as a function of a code applied onto the mailpieces. This code is read into the sorting system and a mailpiece is diverted on the basis of the read-in code.

In an advantageous exemplary embodiment of the present invention, it is provided that the mailpieces that are addressed to a certain delivery point that is described by attributes in the manner described above are associated with the RIO-ID of this delivery point before the mailpieces are placed into the sorting system. In order to be able to effectuate this association, the mailpiece features corresponding to the attributes are detected. The RIO-ID ascertained on the basis of these mailpiece features or attributes can then be applied, for example, as a barcode, onto the mailpieces.

Within the sorting plans, associations of RIO-IDs with sorting compartments are indicated so that, as a function of the applied RIO-ID, a mailpiece within the sorting system can be diverted into a sorting compartment. In particular, a sorting compartment that is associated with a certain node of the postal distribution network is associated with the RIO-IDs with which mailpieces can be associated whose transportation route contains this node. For example, if it is provided that, within the scope of a fine sorting program of the incoming sorting, all of the mailpieces for a delivery district are to be diverted into a certain sorting compartment then, this sorting compartment is associated with the RIO-IDs of all of the delivery points contained in the delivery district within the sorting plan.

In another exemplary embodiment of the invention, it can also be provided that the delivery points are additionally associated with sorting codes and that the sorting plans contain associations between sorting codes or sorting code ranges and sorting compartments. Fundamentally, these can be the sorting codes described above according to the state of the art, whereby in this case as well, the advantage according to an exemplary embodiment of the present invention may provide that the nodes of the postal distribution network and thus the transportation routes of mailpieces can be specified independently of the sorting code and in a clear manner.

The sorting codes can be construed here especially as any desired codes that identify delivery points. To a certain extent, the individual positions of the code lose their significance within the scope of an exemplary embodiment of the present invention as far as the specification of transportation routes is concerned. Thus, within the scope of an exemplary embodiment of the present invention, for example, a mailpiece that is addressed to a delivery point with which a certain sorting code is associated whose first digits designate a certain region can be associated with a distribution center of another region for its incoming sorting in a simple and comprehensible manner.

1-21. (canceled)

22. A logistics system for transporting a mailpiece along a transportation route within a postal distribution network, the transportation route comprising a plurality of nodes of the postal distribution network, the logistics system comprising:
a node that corresponds to a delivery point, the node being associated with a first unambiguous identifier;
a node that corresponds to a sorting point, the second node being associated with a second unambiguous identifier; and
a node that corresponds to a subsequent node in the transportation route being associated with a third unambiguous identifier, the node that corresponds to the subsequent node in the transportation route being associated with another node that either precedes or follows the subsequent node in the transportation route.

23. The logistics system according to claim 22, wherein the association of the third unambiguous identifier with a fourth unambiguous identifier corresponding to the another node is variable.

24. The logistics system according to claim 22, wherein each node in the transportation route of the mailpiece, except for a first node in the transportation route of the mailpiece, associated with the unambiguous identifier of a preceding node.

25. The logistics system according to claim 22, wherein each node in the transportation route of the mailpiece, except for a node that corresponds to a delivery point of the mailpiece, is associated with an unambiguous identifier of a subsequent node along the transportation route.

26. The logistics system according to claim 22, wherein descriptive attributes are associated with each of the plurality of nodes.

27. The logistics system according to claim 22, wherein a node that corresponds to a delivery point is associated with at least one feature of a mailpiece addressed to the delivery point.

28. The logistics system according to claim 22, wherein a node that corresponds to a delivery point is associated with a delivery address that is to be applied onto a mailpiece addressed to the delivery point.

29. The logistics system according to claim 22, wherein at least one of the plurality of nodes is associated with a delivery company that transports a mailpiece to the node.

30. The logistics system according to claim 22, wherein a node that corresponds to a delivery point is associated with a delivery company that delivers mailpieces to the delivery point.

31. The logistics system according to claim 22, wherein the transportation route of the mailpiece is stored in a database.

32. The logistics system according to claim 31, wherein an association between nodes comprising the transportation route and corresponding unambiguous identifiers is stored in the database.

33. The logistics system according to claim 31, wherein an association between nodes of the transportation route and their attributes is stored in the database.

34. The logistics system according to claim 31, an association between a first one of the plurality of nodes and a second one of the plurality of nodes is stored in the database, whereby the second one of the plurality of nodes precedes or follows the first node along the transportation route of the mailpiece.

35. The logistics system according to claim 22, wherein during a sorting at one of the plurality of nodes that corresponds to a sorting point, on the basis of a sorting plan, the mailpiece is relayed to a node that follows along the transportation route of the mailpiece.

36. The logistics system according to claim 35, wherein the sorting plan is generated within the database on the basis of the specification of transportation routes of mailpieces.

37. The logistics system according to claim 22, wherein an unambiguous identifier of a node associated with a delivery point is applied onto a mailpiece addressed to the delivery point and is used during the sorting of the mailpiece.

38. The logistics system according to claim 37, wherein a subset of the plurality of are contained in the transportation route of a mailpiece that is addressed to a delivery point that corresponds to a one of the plurality of nodes of the postal distribution network, and wherein unambiguous identifiers corresponding to the subset of nodes being associated with the node within the sorting plan.

39. The logistics system according to claim 22, wherein a sorting code and/or a sorting code range is associated with the plurality of nodes.

40. The logistics system according to claim 39, wherein a node that corresponds to a delivery point is associated with a sorting code that can be applied onto a mailpiece addressed to the delivery point and that can be used during the sorting of the mailpiece at a sorting point.

41. The logistics system according to claim 39, wherein the mailpiece is relayed from a first node that corresponds to a sorting point to a second node that follows along the transportation route, the second node being associated, within the sorting plan, with the sorting code applied onto the mailpiece and/or with a sorting code range that contains the sorting code applied onto the mailpiece.

42. A method for specifying a transportation route of a mailpiece within a postal distribution network, the transportation route comprising a plurality of nodes of the postal distribution network, in particular a node that corresponds to a delivery point, as well as at least one node that corresponds to a sorting point, the method comprising:
associating an unambiguous identifier with each of the plurality of the nodes;
associating one of the plurality of nodes with another of the plurality of nodes the either precedes or follows the one of the plurality of nodes along the transportation route of the mailpiece; and
routing the mailpiece along the transportation route to a destination node based on the association between the one of the plurality of nodes and the another of the plurality of nodes.

43. A logistics system that specifies a transportation route of a mailpiece within a postal distribution network, the transportation route comprising a plurality of nodes of the postal distribution network, in particular a node that corresponds to a delivery point, as well as at least one node that corresponds to a sorting point, the logistics system comprising:
means for associating an unambiguous identifier with each of the plurality of the nodes;
means for associating one of the plurality of nodes with another of the plurality of nodes the either precedes or follows the one of the plurality of nodes along the transportation route of the mailpiece; and
means for routing the mailpiece along the transportation route to a destination node based on the association between the one of the plurality of nodes and the another of the plurality of nodes.
